(19) United States
(12) Patent Application Publication
(10) Pub. No.: US 2026/0166981 A1
(43) Pub. Date: Jun. 18, 2026

(54) VEHICLE LOWER STRUCTURE

(71) Applicant: HONDA MOTOR CO., LTD., Tokyo (JP)

(72) Inventors: Yuki MATSUSHIMA, Tokyo (JP); Shinya NAKAYAMA, Tokyo (JP)

(73) Assignee: HONDA MOTOR CO., LTD., Tokyo (JP)

(21) Appl. No.: 19/411,395

(22) Filed: Dec. 8, 2025

(30) Foreign Application Priority Data
Dec. 12, 2024 (JP) 2024-218098

(51) Int. Cl. B60K 1/04; B62D 21/02; B62D 25/02; H01M 50/242; H01M 50/249

(52) U.S. Cl. CPC B60K 1/04; B62D 21/02; B62D 25/025; H01M 50/242; H01M 50/249; B60K 2001/0438; H01M 2220/20

(57) ABSTRACT

A vehicle lower structure includes: a battery pack; a cross member; a battery side frame; and a side sill, when viewed in the vehicle width direction, at least a part of the cross member overlaps the side sill, and at least a part of the battery side frame overlaps the side sill, the cross member has a closed cross-sectional shape or an open cross-sectional shape in a cross section perpendicular to the vehicle width direction, a thickness of an outer portion of the cross member is smaller than a thickness of an inner portion of the cross member, the battery side frame has a closed cross-sectional shape or an open cross-sectional shape in a cross section perpendicular to the vehicle front-rear direction, and a thickness of an outer portion of the battery side frame is smaller than a thickness of an inner portion of the battery side frame.

### CROSS-REFERENCE TO RELATED APPLICATION

This application is based on and claims priority under 35 USC 119 from Japanese Patent Application No. 2024-218098 filed on Dec. 12, 2024.

### TECHNICAL FIELD

The present disclosure relates to a vehicle lower structure.

### BACKGROUND ART

In recent years, active efforts have been made to provide access to a sustainable transportation system in consideration of vulnerable people such as the elderly, the disabled person, and children among traffic participants. In order to implement the above, focus has been placed on research and development on further improving safety and convenience of traffic by development related to collision safety performance. For example, Patent Literatures 1 to 3 propose a vehicle body structure for improving safety performance against a side collision.

A vehicle lower structure described in Patent Literature 1 includes a rocker disposed on each of both outer sides in a vehicle width direction. The rocker includes an outer portion and an inner portion that form a closed cross section portion, and a shock absorbing portion provided between the outer portion and the inner portion, and the outer portion, the inner portion, and the shock absorbing portion are integrally formed by extrusion or the like. This vehicle lower structure plastically deforms the shock absorbing portion to absorb a load input to the rocker due to a side collision.

A vehicle body lower structure described in Patent Literature 2 includes a side frame that connects a battery pack to a side sill disposed more outward than the battery pack in a vehicle width direction. The vehicle body lower structure plastically deforms the side frame to absorb a load input to the side sill due to a side collision.

A floor structure of a vehicle body described in Patent Literature 3 folds a cross member, which extends inward in a vehicle width direction from a side sill, at a plurality of positions in the vehicle width direction to absorb a load input to the side sill due to a side collision.
Patent Literature 1: JP2021-088364A
Patent Literature 2: JP2024-051735A
Patent Literature 3: JP2021-146885A

### SUMMARY OF INVENTION

An object of the present invention is to appropriately distribute and absorb a load input to a vehicle due to a side collision.

A vehicle lower structure according to an aspect of the present invention includes:
a battery pack including a battery and a case accommodating the battery;
a cross member disposed above the battery pack and extending in a vehicle width direction;
a battery side frame disposed more outward than the battery pack in the vehicle width direction and configured to support a side portion of the battery pack; and
a side sill disposed more outward than the cross member and the battery side frame in the vehicle width direction and extending in a vehicle front-rear direction, in which
when viewed in the vehicle width direction, at least a part of the cross member overlaps the side sill, and at least a part of the battery side frame overlaps the side sill,
the cross member has a closed cross-sectional shape or an open cross-sectional shape in a cross section perpendicular to the vehicle width direction,
a thickness of an outer portion of the cross member in the vehicle width direction is smaller than a thickness of an inner portion of the cross member in the vehicle width direction,
the battery side frame has a closed cross-sectional shape or an open cross-sectional shape in a cross section perpendicular to the vehicle front-rear direction, and
a thickness of an outer portion of the battery side frame in the vehicle width direction is smaller than a thickness of an inner portion of the battery side frame in the vehicle width direction.

A vehicle lower structure according to another aspect of the present invention includes:
a battery pack including a battery and a case accommodating the battery;
a cross member disposed above the battery pack and extending in a vehicle width direction;
a battery side frame disposed more outward than the battery pack in the vehicle width direction and configured to support a side portion of the battery pack; and
a side sill disposed more outward than the cross member and the battery side frame in the vehicle width direction and extending in a vehicle front-rear direction, in which
when viewed in the vehicle width direction, at least a part of the cross member overlaps the side sill, and at least a part of the battery side frame overlaps the side sill,
the cross member has a closed cross-sectional shape or an open cross-sectional shape in a cross section perpendicular to the vehicle width direction,
a thickness of an outer portion of the cross member in the vehicle width direction is smaller than a thickness of an inner portion of the cross member in the vehicle width direction,
the battery side frame has a closed cross-sectional shape or an open cross-sectional shape in a cross section perpendicular to the vehicle front-rear direction,
a thickness of an outer portion of the battery side frame in the vehicle width direction is smaller than a thickness of an inner portion of the battery side frame in the vehicle width direction,
the side sill has a closed cross-sectional shape or an open cross-sectional shape in a cross section perpendicular to the vehicle front-rear direction, including a plurality of lateral plates extending in the vehicle width direction, and
at least one lateral plate among the plurality of lateral plates has a different thickness from other lateral plates among the plurality of lateral plates.

According to the present invention, it is possible to appropriately distribute and absorb a load input to a vehicle due to a side collision.

### BRIEF DESCRIPTION OF DRAWINGS

FIG. 1 is a perspective view of an example of a vehicle lower structure for illustrating an embodiment of the present invention.

FIG. 2 is a cross-sectional view taken along a line II-II in FIG. 1.

FIG. 3 is a cross-sectional view taken along a line III-III in FIG. 1.

FIG. 4 is a cross-sectional view of an example of the vehicle lower structure for illustrating the embodiment of the present invention.

FIG. 5 is a cross-sectional view of a modification of the vehicle lower structure of FIG. 4.

FIG. 6 is a cross-sectional view of another modification of the vehicle lower structure of FIG. 4.

FIG. 7 is a cross-sectional view of another modification of the vehicle lower structure of FIG. 4.

FIG. 8 is a cross-sectional view of another modification of the vehicle lower structure of FIG. 4.

### DESCRIPTION OF EMBODIMENTS

An example of a vehicle lower structure for illustrating an embodiment of the present invention will be described with reference to the accompanying drawings. The drawings are viewed from directions of reference numerals. In the present specification and the like, in order to simplify and clarify the description, a front-rear direction, a left-right direction, and an upper-lower direction are described according to directions viewed from a driver of a vehicle. In the drawings, a front side of the vehicle is shown as Fr, a rear side is shown as Rr, a left side is shown as L, a right side is shown as R, an upper side is shown as U, and a lower side is shown as D.

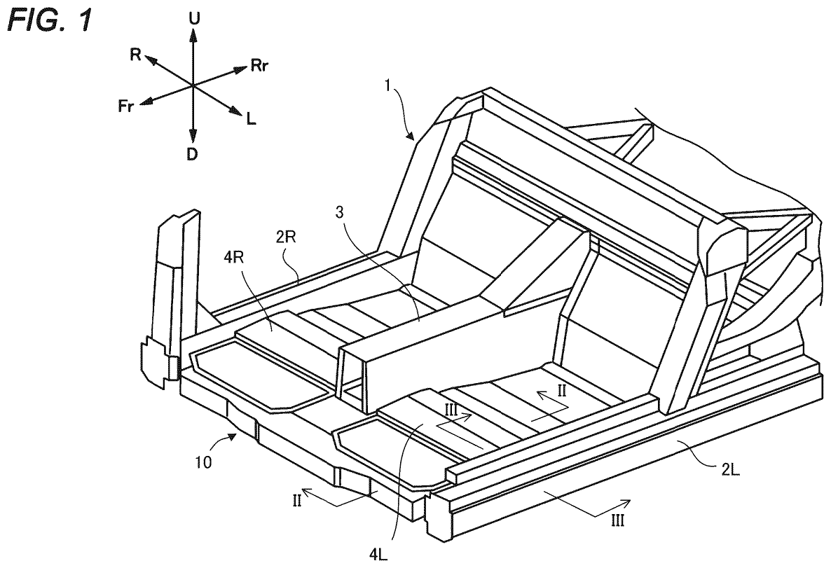

The vehicle lower structure shown in FIGS. 1 to 3 is a lower structure of an electric vehicle such as a battery electric automobile, a hybrid vehicle (including a plug-in hybrid vehicle), or a fuel cell vehicle. The vehicle lower structure includes a vehicle body 1 and a battery pack 10. The vehicle body 1 constitutes a framework of the vehicle, and the battery pack 10 stores and discharges electric power to be supplied to a motor or the like serving as a drive source of the vehicle.

The vehicle body 1 includes side sills 2L and 2R, a center tunnel 3, and cross members 4L and 4R. The side sills 2L and 2R, the center tunnel 3, and the cross members 4L and 4R constitute a part of the framework of the vehicle. Although not shown, the vehicle body 1 may also include a floor panel, other cross members disposed at a front side or a rear side of the cross members 4L and 4R, and the like.

The side sills 2L and 2R are disposed at an interval in a vehicle width direction (left-right direction) and extend in a vehicle front-rear direction. The center tunnel 3 is disposed between the side sills 2L and 2R and extends in the vehicle front-rear direction. The cross member 4L is disposed between the side sill 2L and the center tunnel 3, and the cross member 4R is disposed between the center tunnel 3 and the side sill 2R, each of the cross members extends in the vehicle width direction. End portions of the cross member 4L are joined to the side sill 2L and the center tunnel 3 by an appropriate method such as welding or fastening using a bolt or a rivet. End portions of the cross member 4R are also joined to the center tunnel 3 and the side sill 2R by an appropriate method such as welding or fastening.

The cross members 4L and 4R are on the same line extending in the vehicle width direction, are coupled via the center tunnel 3, and are integrally bridged between the side sills 2L and 2R. The center tunnel 3 is provided to increase rigidity of the vehicle body 1 and/or to accommodate a wire harness extending from the battery pack 10. However, the center tunnel 3 may be omitted. When the center tunnel 3 is omitted, the cross members 4L and 4R are implemented by a single member and are bridged between the side sills 2L and 2R.

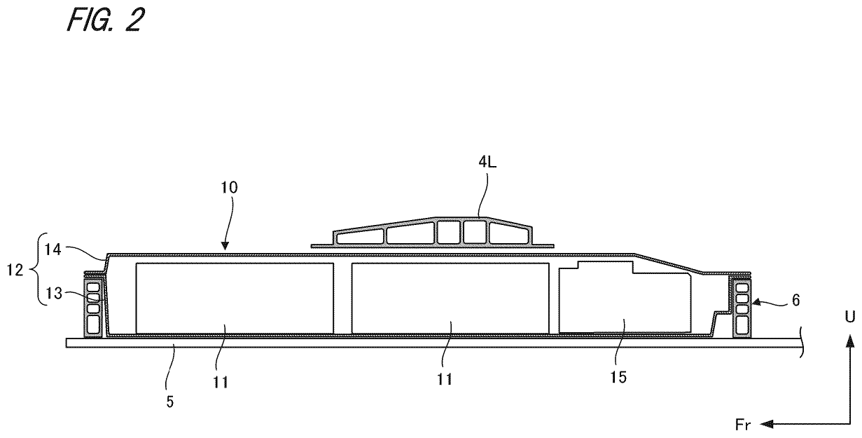

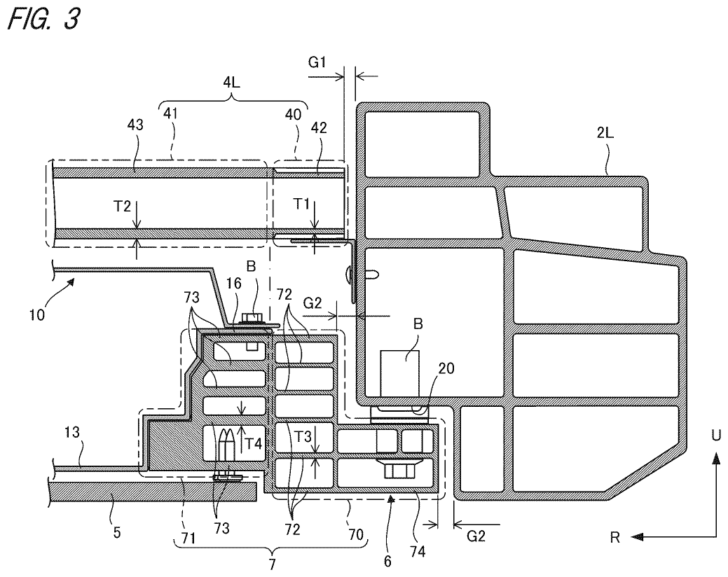

The battery pack 10 is disposed between the side sills 2L and 2R in the vehicle width direction and is disposed below the cross members 4L and 4R. As shown in FIGS. 2 and 3, the battery pack 10 includes a battery 11 and a case 12 that accommodates the battery 11.

The battery 11 includes a plurality of battery cells. The battery cell is, for example, a lithium ion battery or a nickel hydrogen battery using a liquid electrolyte, or an all-solid-state battery using a solid electrolyte. The battery 11 is typically modularized in a state where a plurality of battery cells are connected in series and/or in parallel. In an example shown in FIG. 2, two modularized batteries 11 are arranged side by side in the front-rear direction, but the number and arrangement of the batteries 11 are not particularly limited.

The case 12 includes a case body 13 and a case cover 14. The case body 13 is formed in a tray shape capable of accommodating the battery 11. The case body 13 is implemented by a plate material made of a metal such as an aluminum alloy or steel. The case cover 14 covers the case body 13 from above. An electrical device 15, such as a junction box or a bus bar, is also accommodated in the case 12. The junction box controls connection between the battery pack 10 and an inverter that drives a charging system or a motor mounted on the vehicle. The bus bar connects the modularized batteries 11 to each other and connects the batteries 11 to the junction box.

The battery pack 10 is fixed to the vehicle body 1 via a base plate 5 and a battery frame 6. The battery pack 10 is placed on the base plate 5, and the case body 13 of the battery pack 10 is fixed to the base plate 5. Edge portions of the base plate 5 extend more outward than the battery pack 10 in the vehicle front-rear direction and the vehicle width direction. The battery frame 6 is provided to surround the battery pack 10, and is joined to the edge portions of the base plate 5 by an appropriate method such as welding or fastening. The battery frame 6 is fixed to the vehicle body 1. Fixing locations of the battery frame 6 on the vehicle body 1 are appropriately set, and for example, may include the side sills 2L and 2R, other cross members positioned in the front side and the rear side of the cross members 4L and 4R, or a floor panel. The case body 13 may be fixed to the battery frame 6 in addition to the base plate 5 or instead of the base plate 5.

FIG. 3 shows a structure around the side sill 2L. A structure around the side sill 2R is similarly configured. The battery frame 6 includes a battery side frame 7 that supports a side portion of the battery pack 10 near the side sill 2L. The battery side frame 7 extends in the vehicle front-rear direction between the battery pack 10 and the side sill 2L.

When viewed in the vehicle width direction, the cross member 4L overlaps the side sill 2L, and the battery side frame 7 overlaps the side sill 2L. When a load is input to the side sill 2L from the outside in the vehicle width direction, the input load is distributed and transmitted to the cross member 4L and the battery side frame 7. From a viewpoint of transmitting the load to the cross member 4L and the battery side frame 7, when viewed in the vehicle width direction, at least a part of the cross member 4L may overlap the side sill 2L and at least a part of the battery side frame 7 may overlap the side sill 2L.

The load transmitted to the cross member 4L is borne by the center tunnel 3 and further borne by the side sill 2R via the cross member 4R. The load transmitted to the battery side frame 7 is borne by the battery pack 10. Accordingly, a reaction force against the side sill 2L is generated, and excessive inward intrusion of the side sill 2L in the vehicle width direction is prevented.

Here, the side sill 2L, the cross member 4L, and the battery side frame 7 have a closed cross-sectional shape or an open cross-sectional shape in a cross section perpendicular to an extending direction. That is, the side sill 2L, the cross member 4L, and the battery side frame 7 are members implemented by a combination of lateral plates and vertical plates, and are, for example, extruded materials made of an aluminum alloy. Thicknesses of an outer portion 40 and an inner portion 41 of the cross member 4L in the vehicle width direction, and thicknesses of an outer portion 70 and an inner portion 71 of the battery side frame 7 in the vehicle width direction refer to thicknesses of the lateral plates and/or vertical plates that constituting the respective portions, the thickness of the outer portion 40 of the cross member 4L in the vehicle width direction is smaller than the thickness of the inner portion 41, and the thickness of the outer portion 70 of the battery side frame 7 is smaller than the thickness of the inner portion 71.

In an example shown in FIG. 3, a thickness T1 of a lateral plate 42 of the outer portion 40 of the cross member 4L in the vehicle width direction is smaller than a thickness T2 of a lateral plate 43 of the inner portion 41. A thickness T3 of a lateral plate 72 of the outer portion 70 of the battery side frame 7 in the vehicle width direction is smaller than a thickness T4 of a lateral plate 73 of the inner portion 71. The outer portion 40 having a relatively small thickness in the cross member 4L functions as a shock absorbing portion. The outer portion 40 is plastically deformed by the load transmitted to the cross member 4L, and a part of the load is absorbed. Similarly, the outer portion 70 having a relatively small thickness in the battery side frame 7 functions as a shock absorbing portion. The outer portion 70 is plastically deformed by the load transmitted to the battery side frame 7, and a part of the load is absorbed.

In this way, by distributing the load input to the side sill 2L to the cross member 4L and the battery side frame 7, it is possible to alleviate strength requirements for the cross member 4L and the battery side frame 7, and the center tunnel 3, the side sill 2R, and the battery pack 10 that bear the load transmitted to the cross member 4L and the battery side frame 7. The load distributed to the cross member 4L and the battery side frame 7 is absorbed by the shock absorbing portions (the outer portion 40 of the cross member 4L and the outer portion 70 of the battery side frame 7) provided in the cross member 4L and the battery side frame 7, respectively, so that sufficient shock absorption can be implemented as a whole while reducing a deformation amount of each of the shock absorbing portions.

Preferably, the battery side frame 7 is joined to the side sill 2L. Accordingly, regardless of the deformation of the battery side frame 7 when the load is input, a load transmission path from the side sill 2L to the battery side frame 7 can be maintained, and the load can be reliably transmitted from the side sill 2L to the battery side frame 7. In the example shown in FIG. 3, the battery side frame 7 includes a protruding portion 74 that protrudes outward from the outer portion 70 in the vehicle width direction, and the side sill 2L is provided with a recessed portion 20 that accommodates the protruding portion 74. The protruding portion 74 accommodated in the recessed portion 20 is fastened to the recessed portion 20 in the upper-lower direction by a bolt B. In this way, the protruding portion 74 that protrudes outward in the vehicle width direction and the recessed portion 20 that accommodates the protruding portion 74 are provided, and the protruding portion 74 and the recessed portion 20 are joined together in the upper-lower direction that intersects the vehicle width direction, so that strength of a joined location can be ensured.

Preferably, the battery pack 10 is fixed to the battery side frame 7, and more preferably, the battery pack 10 is fixed to the inner portion 71 having relatively high strength of the battery side frame 7. Accordingly, regardless of the deformation of the battery side frame 7 when the load is input, a load transmission path from the battery side frame 7 to the battery pack 10 can be maintained, and the load can be reliably borne by the battery pack 10. In the example shown in FIG. 3, the case body 13 of the battery pack 10 has a flange 16 that extends outward in the vehicle width direction, and the flange 16 is superimposed on an upper surface of the inner portion 71 of the battery side frame 7 and is fastened to the inner portion 71 by a bolt B.

Preferably, a boundary between the outer portion 40 and the inner portion 41 of the cross member 4L and a boundary between the outer portion 70 and the inner portion 71 of the battery side frame 7 are at the same position in the vehicle width direction. Accordingly, both the outer portion 40 of the cross member 4L and the outer portion 70 of the battery side frame 7, which function as the shock absorbing portions, can be sufficiently deformed, and effective shock absorption can be implemented.

From a viewpoint of the shock absorption, as shown in FIG. 3, a gap G1 may be provided between an end surface of the outer portion 40 of the cross member 4L and a side surface of the side sill 2L facing this end surface in the vehicle width direction, and a gap G2 may be provided between an end surface of the outer portion 70 (including the protruding portion 74) of the battery side frame 7 and a side surface of the side sill 2L facing this end surface in the vehicle width direction. These gaps G1 and G2 allow the side sill 2L to be displaced inward in the vehicle width direction when a load is input to the side sill 2L from the outside in the vehicle width direction. Accordingly, it is possible to further perform the shock absorption by using a deflection of the side sill 2L.

The gap G1 between the cross member 4L and the side sill 2L and the gap G2 between the battery side frame 7 and the side sill 2L may be the same or different. By making the gaps G1 and G2 different, a timing at which the end surface of the outer portion 40 of the cross member 4L and the side surface of the side sill 2L come into contact with each other and a timing at which the end surface of the outer portion 70 of the battery side frame 7 and the side surface of the side sill 2L come into contact with each other can be made different from each other, and a distribution ratio of the load to the cross member 4L and the battery side frame 7 can be controlled.

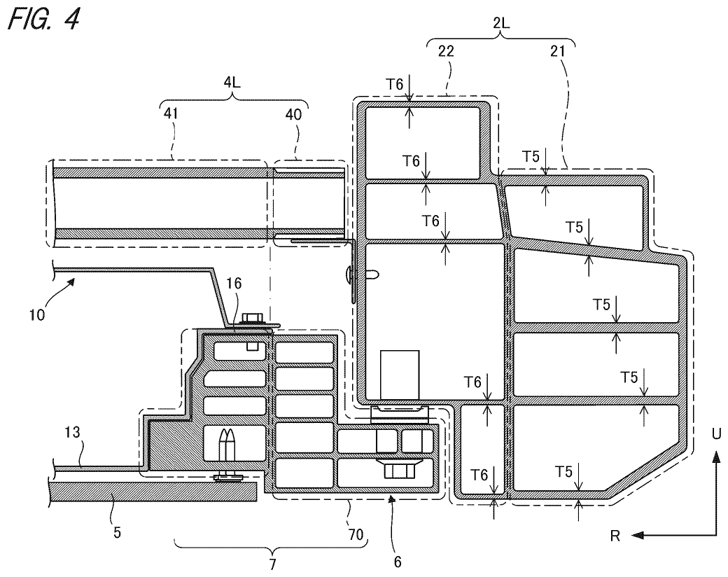

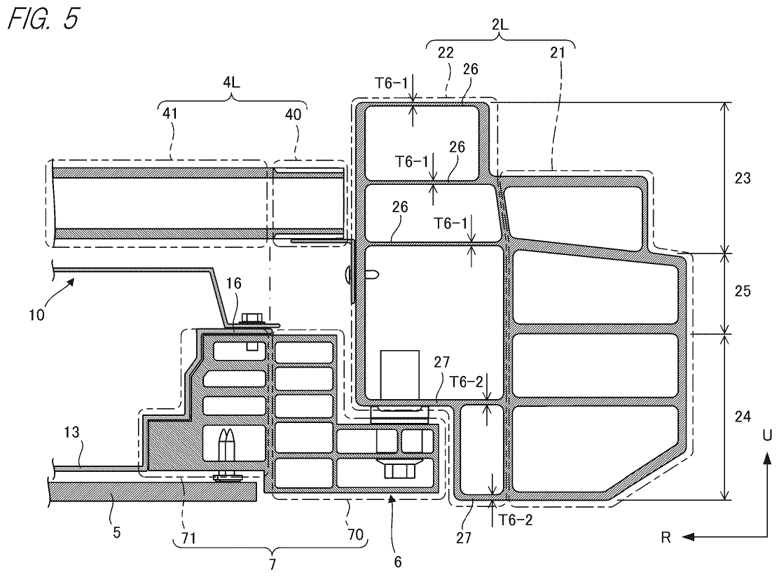

In the vehicle lower structure shown in FIG. 4, the side sill 2L is used for the shock absorption, and in modifications shown in FIGS. 5 to 8, the side sill 2L is used for control of the distribution ratio of the load to the cross member 4L and the battery side frame 7 in addition to the shock absorption. In the vehicle lower structure shown in FIGS. 4 to 8, elements common to those of the vehicle lower structure shown in FIGS. 1 to 3 are denoted by common reference numerals, and descriptions thereof will be omitted.

As described above, the side sill 2L is a member implemented by a combination of the lateral plates and the vertical plates, and has a closed cross-sectional shape or an open cross-sectional shape in a cross section perpendicular to the extending direction. Thicknesses of the lateral plates positioned at an outer portion 21 of the side sill 2L are the same, and each of the thicknesses is set as a thickness T5. Thicknesses of the lateral plates at an inner portion 22 of the side sill 2L in the vehicle width direction are the same, and each of the thicknesses is set as a thickness T6 smaller than the thickness T5 of the lateral plate at the outer portion 21. In the side sill 2L, the inner portion 22 having the lateral plates with smaller thicknesses functions as the shock absorbing portion. The inner portion 22 is plastically deformed by the load input to the side sill 2L, and a part of the load is absorbed.

By making all the lateral plates positioned at the outer portion 21 of the side sill 2L have the same thickness, the load input to the outer portion 21 from the outside in the vehicle width direction can be transmitted to the inner portion 22 without deviation. On the other hand, the lateral plates positioned at the inner portion 22 may have different thicknesses. By setting the thicknesses of the lateral plates positioned at the inner portion 22 differently, the distribution ratio of the load to the cross member 4L and the battery side frame 7 can be controlled.

In an example shown in FIG. 5, a thickness T6-1 of each of lateral plates 26 positioned at an upper portion 23 overlapping at least a part of the cross member 4L among the lateral plates of the inner portion 22 of the side sill 2L is smaller than a thickness T6-2 of each of lateral plates 27 positioned at a lower portion 24 overlapping at least a part of the battery side frame 7. In this case, a load transmission ratio from the upper portion 23 having the lateral plates with relatively small thicknesses to the cross member 4L becomes small, and the load transmission ratio from the lower portion 24 having the lateral plates with relatively large thicknesses to the battery side frame 7 becomes large.

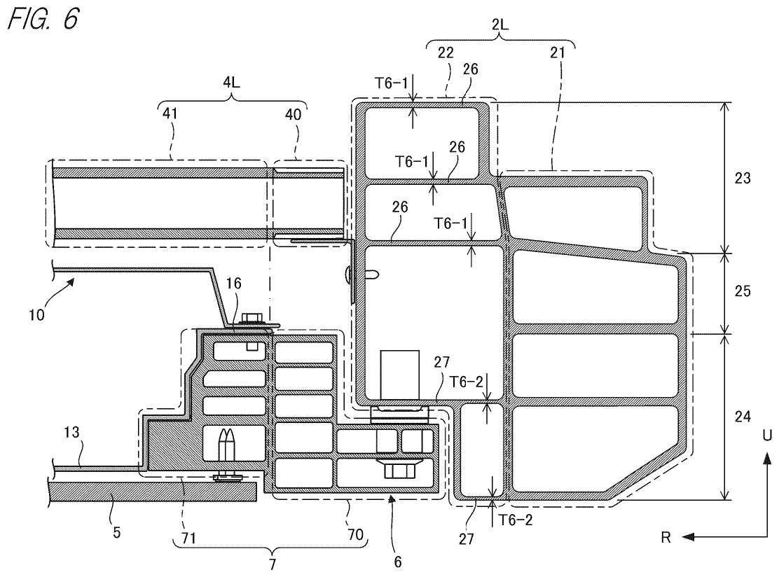

On the other hand, in an example shown in FIG. 6, the thickness T6-2 of each of the lateral plates 27 positioned at the lower portion 24 overlapping at least a part of the battery side frame 7 among the lateral plates of the inner portion 22 of the side sill 2L is smaller than the thickness T6-1 of each of the lateral plates 26 positioned at the upper portion 23 overlapping at least a part of the cross member 4L. In this case, the load transmission ratio from the lower portion 24 having the lateral plates with relatively small thicknesses to the battery side frame 7 becomes small, and the load transmission ratio from the upper portion 23 having the lateral plates with relatively large thicknesses to the cross member 4L becomes large.

As shown in FIGS. 5 and 6, the lateral plates at the inner portion 22 of the side sill 2L may be omitted to be hollow at an intermediate portion 25 between the upper portion 23 of the side sill 2L overlapping the cross member 4L and the lower portion 24 of the side sill 2L overlapping the battery side frame 7. Accordingly, the load can be effectively transmitted to the cross member 4L and the battery side frame 7 by guiding the load to the upper portion 23 and the lower portion 24.

In the side sill 2L, thicknesses of the plurality of vertical plates bridged between the plurality of lateral plates may be different.

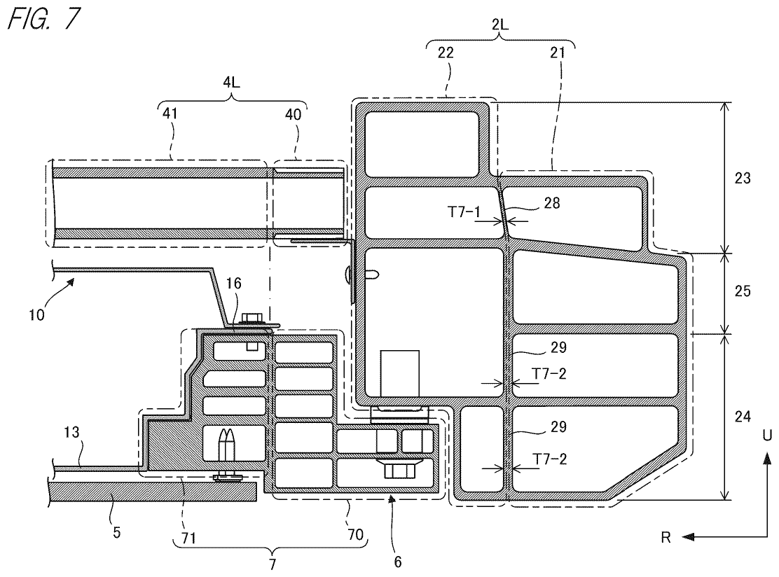

In an example shown in FIG. 7, a thickness T7-1 of a vertical plate 28 positioned at the upper portion 23 of the side sill 2L overlapping at least a part of the cross member 4L is smaller than a thickness T7-2 of each of vertical plates 29 positioned at the lower portion 24 of the side sill 2L overlapping at least a part of the battery side frame 7. In this case, a load transmission ratio from the upper portion 23 having the vertical plate with a relatively small thickness to the cross member 4L becomes small, and a load transmission ratio from the lower portion 24 having the vertical plates with relatively large thicknesses to the battery side frame 7 becomes large.

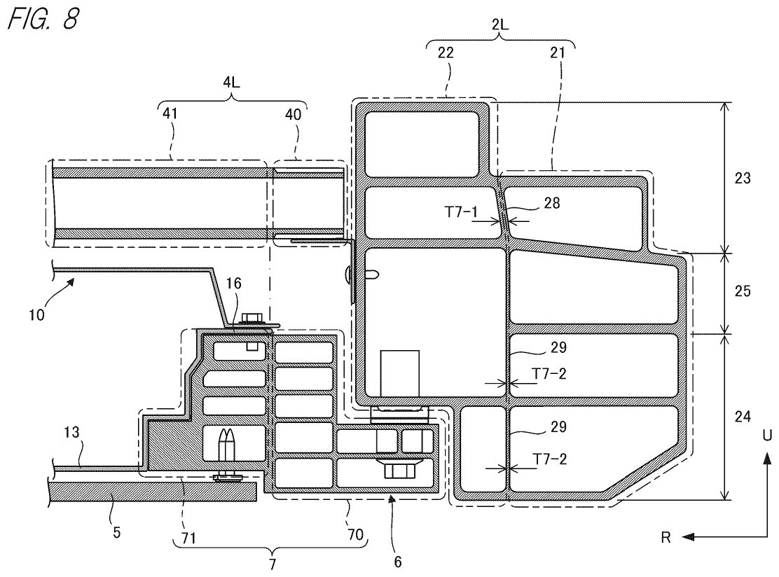

On the other hand, in an example shown in FIG. 8, the thickness T7-2 of each of the vertical plates 29 positioned at the lower portion 24 of the side sill 2L is smaller than the thickness T7-1 of the vertical plate 28 positioned at the upper portion 23 of the side sill 2L. In this case, the load transmission ratio from the lower portion 24 having the vertical plates with relatively small thicknesses to the battery side frame 7 becomes small, and the load transmission ratio from the upper portion 23 having the vertical plate with a relatively large thickness to the cross member 4L becomes large.

The embodiment of the present invention has been described above, but the present invention is not limited to the embodiment described above, and modifications, improvements, and the like can be made as appropriate. In the present description, at least the following matters are described. Although corresponding constituent elements or the like in the above-described embodiment are shown in parentheses, the present invention is not limited thereto.

(1) A vehicle lower structure including:
a battery pack (battery pack 10) including a battery (battery 11) and a case (case 12) accommodating the battery;
a cross member (cross members 4L and 4R) disposed above the battery pack and extending in a vehicle width direction;
a battery side frame (battery side frame 7) disposed more outward than the battery pack in the vehicle width direction and configured to support a side portion of the battery pack; and
a side sill (side sills 2L and 2R) disposed more outward than the cross member and the battery side frame in the vehicle width direction and extending in a vehicle front-rear direction, in which
when viewed in the vehicle width direction, at least a part of the cross member overlaps the side sill, and at least a part of the battery side frame overlaps the side sill,
the cross member has a closed cross-sectional shape or an open cross-sectional shape in a cross section perpendicular to the vehicle width direction,
a thickness (thickness T1) of an outer portion (outer portion 40) of the cross member in the vehicle width direction is smaller than a thickness (thickness T2) of an inner portion (inner portion 41) of the cross member in the vehicle width direction,
the battery side frame has a closed cross-sectional shape or an open cross-sectional shape in a cross section perpendicular to the vehicle front-rear direction, and
a thickness (thickness T3) of an outer portion (outer portion 70) of the battery side frame in the vehicle width direction is smaller than a thickness (thickness T4) of an inner portion (inner portion 71) of the battery side frame in the vehicle width direction.

According to the vehicle lower structure of the above (1), a load input to the side sill can be distributed to the cross member and the battery side frame. A part of the load transmitted to the cross member is absorbed by the plastic deformation in the vehicle width direction of the outer portion having a relatively small thickness in the cross member, and a part of the load transmitted to the battery side frame is absorbed by the plastic deformation in the vehicle width direction of the outer portion having a relatively small thickness in the battery side frame, so that it is possible to implement sufficient shock absorption as a whole while reducing a deformation amount of each of the portions.

(2) The vehicle lower structure according to the above (1), in which
when a load is input to the side sill from an outside in the vehicle width direction, the load is transmitted from the side sill to the cross member and the battery side frame, and
the load transmitted to the battery side frame is transmitted to the battery pack.

(3) The vehicle lower structure according to the above (1), in which
the cross member and the battery side frame are disposed with a gap (gaps G1 and G2) from the side sill in the vehicle width direction.

According to the vehicle lower structure of the above (3), when the load is input to the side sill from the outside in the vehicle width direction, the side sill is allowed to be displaced inward in the vehicle width direction, and a deflection of the side sill can be used to further perform shock absorption.

(4) The vehicle lower structure according to the above (1), in which
the battery pack is fixed to the inner portion of the battery side frame in the vehicle width direction.

According to the vehicle lower structure of the above (4), regardless of the deformation of the battery side frame when the load is input, a load transmission path from the battery side frame to the battery pack can be maintained, and the load can be reliably borne by the battery pack.

(5) The vehicle lower structure according to the above (4), in which
a boundary between the outer portion and the inner portion of the cross member in the vehicle width direction and a boundary between the outer portion and the inner portion of the battery side frame in the vehicle width direction are at the same position in the vehicle width direction.

According to the vehicle lower structure of the above (5), it is possible to sufficiently deform both the outer portion of the cross member and the outer portion of the battery side frame that function as shock absorbing portions, and to implement effective shock absorption.

(6) The vehicle lower structure according to the above (1), in which
the outer portion of the battery side frame in the vehicle width direction has a protruding portion (protruding portion 74) that protrudes in the vehicle width direction,
the side sill has a recessed portion (recessed portion 20) that accommodates the protruding portion of the battery side frame, and
the protruding portion is fastened to the recessed portion in a direction intersecting the vehicle width direction.

According to the vehicle lower structure of the above (6), regardless of the deformation of the battery side frame when the load is input, a load transmission path from the side sill to the battery side frame can be maintained, and the load can be reliably transmitted from the side sill to the battery side frame. Furthermore, by joining the protruding portion protruding outward in the vehicle width direction to the recessed portion accommodating the protruding portion in an upper-lower direction that intersects the vehicle width direction, strength of a joining location can be ensured.

(7) A vehicle lower structure including:
a battery pack (battery pack 10) including a battery (battery 11) and a case (case 12) accommodating the battery;
a cross member (cross members 4L and 4R) disposed above the battery pack and extending in a vehicle width direction;
a battery side frame (battery side frame 7) disposed more outward than the battery pack in the vehicle width direction and configured to support the battery pack; and
a side sill (side sills 2L and 2R) disposed more outward than the cross member and the battery side frame in the vehicle width direction and extending in a vehicle front-rear direction, in which
when viewed in the vehicle width direction, at least a part of the cross member overlaps the side sill, and at least a part of the battery side frame overlaps the side sill,
the cross member has a closed cross-sectional shape or an open cross-sectional shape in a cross section perpendicular to the vehicle width direction,
a thickness (thickness T1) of an outer portion (outer portion 40) of the cross member in the vehicle width direction is smaller than a thickness (thickness T2) of an inner portion (inner portion 41) of the cross member in the vehicle width direction,
the battery side frame has a closed cross-sectional shape or an open cross-sectional shape in a cross section perpendicular to the vehicle front-rear direction,
a thickness (thickness T3) of an outer portion (outer portion 70) of the battery side frame in the vehicle width direction is smaller than a thickness (thickness T4) of an inner portion (inner portion 71) of the battery side frame in the vehicle width direction,
the side sill has a closed cross-sectional shape or an open cross-sectional shape in a cross section perpendicular to the vehicle front-rear direction, including a plurality of lateral plates extending in the vehicle width direction, and
at least one lateral plate among the plurality of lateral plates has a different thickness from other lateral plates among the plurality of lateral plates.

According to the vehicle lower structure of the above (7), a load input to the side sill can be distributed to the cross member and the battery side frame. A part of the load transmitted to the cross member is absorbed by the plastic deformation in the vehicle width direction of the outer portion having a relatively small thickness in the cross member, and a part of the load transmitted to the battery side frame is absorbed by the plastic deformation in the vehicle width direction of the outer portion having a relatively small thickness in the battery side frame, so that it is possible to implement sufficient shock absorption as a whole while reducing a deformation amount of each of the portions. Further, the absorption of the load can be promoted by a plastic deformation of a portion having the lateral plate with a relatively small thickness in the cross member.

(8) The vehicle lower structure according to the above (7), in which
thicknesses (thickness T5) of outer lateral plates positioned at an outer portion (outer portion 21) of the side sill in the vehicle width direction among the plurality of lateral plates are the same.

According to the vehicle lower structure of the above (8), the load input to the outer portion of the side sill in the vehicle width direction from the outside in the vehicle width direction can be transmitted to the inner portion without deviation.

(9) The vehicle lower structure according to the above (8), in which
a thickness (thickness T6) of an inner lateral plate positioned at an inner portion (inner portion 22) of the side sill in the vehicle width direction among the plurality of lateral plates is smaller than the thicknesses (thickness T5) of the outer lateral plates.

According to the vehicle lower structure of the above (9), the inner portion of the side sill having the lateral plates with relatively small thicknesses can function as the shock absorbing portion to absorb a part of the load.

(10) The vehicle lower structure according to the above (8), in which
among inner lateral plates positioned at an inner portion, in the vehicle width direction, of the side sill, a thickness (thickness T6-1) of an inner lateral plate (lateral plate 26) positioned at an upper portion (upper portion 23) of the side sill overlapping at least a part of the cross member is different from a thickness (thickness T6-2) of an inner lateral plate (lateral plate 27) positioned at a lower portion (lower portion 24) of the side sill overlapping at least a part of the battery side frame.

According to the vehicle lower structure of the above (10), it is possible to control a dispersion ratio of the load to the cross member and the battery side frame.

(11) The vehicle lower structure according to the above (8), in which
an inner portion, in the vehicle width direction, of the side sill is hollow at an intermediate portion (intermediate portion 25) of the side sill between an upper portion of the side sill overlapping at least a part of the cross member and a lower portion of the side sill overlapping at least a part of the battery side frame.

According to the vehicle lower structure of the above (11), the load can be effectively transmitted to the cross member and the battery side frame by guiding the load to the upper portion and the lower portion of the side sill.

(12) The vehicle lower structure according to the above (7), in which
the side sill includes a plurality of vertical plates bridged between the plurality of lateral plates, and
among the plurality of vertical plates, a thickness (thickness T7-1) of an upper vertical plate (vertical plate 28) positioned at an upper portion of the side sill overlapping at least a part of the cross member is different from a thickness (thickness T7-2) of a lower vertical plate (vertical plate 29) positioned at a lower portion of the side sill overlapping at least a part of the battery side frame.

According to the vehicle lower structure of the above (12), it is possible to control a dispersion ratio of the load to the cross member and the battery side frame.

### REFERENCE SIGNS LIST

1 vehicle body
2L, 2R side sill
3 center tunnel
4L, 4R cross member
5 base plate
6 battery frame
7 battery side frame
battery pack
11 battery
12 case
13 case body
14 case cover
15 electrical device
16 flange
20 recessed portion
21 outer portion
22 inner portion
23 upper portion
24 lower portion
25 intermediate portion
26, 27 lateral plate
28, 29 vertical plate
40 outer portion
41 inner portion
42, 43 lateral plate
70 outer portion
71 inner portion
72, 73 lateral plate
74 protruding portion
B bolt
G1 gap
G2 gap

What is claimed is:

1. A vehicle lower structure comprising:
a battery pack including a battery and a case accommodating the battery;
a cross member disposed above the battery pack and extending in a vehicle width direction;
a battery side frame disposed more outward than the battery pack in the vehicle width direction and configured to support a side portion of the battery pack; and
a side sill disposed more outward than the cross member and the battery side frame in the vehicle width direction and extending in a vehicle front-rear direction, wherein
when viewed in the vehicle width direction, at least a part of the cross member overlaps the side sill, and at least a part of the battery side frame overlaps the side sill,
the cross member has a closed cross-sectional shape or an open cross-sectional shape in a cross section perpendicular to the vehicle width direction,
a thickness of an outer portion, in the vehicle width direction, of the cross member is smaller than a thickness of an inner portion, in the vehicle width direction, of the cross member,
the battery side frame has a closed cross-sectional shape or an open cross-sectional shape in a cross section perpendicular to the vehicle front-rear direction, and
a thickness of an outer portion, in the vehicle width direction, of the battery side frame is smaller than a thickness of an inner portion, in the vehicle width direction, of the battery side frame.

2. The vehicle lower structure according to claim 1, wherein
when a load is input to the side sill from an outside in the vehicle width direction, the load is transmitted from the side sill to the cross member and the battery side frame, and
the load transmitted to the battery side frame is transmitted to the battery pack.

3. The vehicle lower structure according to claim 1, wherein
the cross member and the battery side frame are disposed with a gap from the side sill in the vehicle width direction.

4. The vehicle lower structure according to claim 1, wherein
the battery pack is fixed to the inner portion, in the vehicle width direction, of the battery side frame.

5. The vehicle lower structure according to claim 4, wherein
a boundary between the outer portion and the inner portion, in the vehicle width direction, of the cross member and a boundary between the outer portion and the inner portion, in the vehicle width direction, of the battery side frame are at a same position in the vehicle width direction.

6. The vehicle lower structure according to claim 1, wherein
the outer portion, in the vehicle width direction, of the battery side frame has a protruding portion that protrudes outward in the vehicle width direction,
the side sill has a recessed portion that accommodates the protruding portion of the battery side frame, and
the protruding portion is fastened to the recessed portion in a direction intersecting the vehicle width direction.

7. A vehicle lower structure comprising:
a battery pack including a battery and a case accommodating the battery;
a cross member disposed above the battery pack and extending in a vehicle width direction;
a battery side frame disposed more outward than the battery pack in the vehicle width direction and configured to support a side portion of the battery pack; and
a side sill disposed more outward than the cross member and the battery side frame in the vehicle width direction and extending in a vehicle front-rear direction, wherein
when viewed in the vehicle width direction, at least a part of the cross member overlaps the side sill, and at least a part of the battery side frame overlaps the side sill,
the cross member has a closed cross-sectional shape or an open cross-sectional shape in a cross section perpendicular to the vehicle width direction,
a thickness of an outer portion, in the vehicle width direction, of the cross member is smaller than a thickness of an inner portion, in the vehicle width direction, of the cross member,
the battery side frame has a closed cross-sectional shape or an open cross-sectional shape in a cross section perpendicular to the vehicle front-rear direction,
a thickness of an outer portion, in the vehicle width direction, of the battery side frame is smaller than a thickness of an inner portion, in the vehicle width direction, of the battery side frame,
the side sill has a closed cross-sectional shape or an open cross-sectional shape in a cross section perpendicular to the vehicle front-rear direction, including a plurality of lateral plates extending in the vehicle width direction, and
at least one lateral plate among the plurality of lateral plates has a different thickness from other lateral plates among the plurality of lateral plates.

8. The vehicle lower structure according to claim 7, wherein
thicknesses of outer lateral plates positioned at an outer portion, in the vehicle width direction, of the side sill among the plurality of lateral plates are the same.

9. The vehicle lower structure according to claim 8, wherein
a thickness of an inner lateral plate positioned at an inner portion, in the vehicle width direction, of the side sill among the plurality of lateral plates is smaller than the thicknesses of the outer lateral plates.

10. The vehicle lower structure according to claim 8, wherein
among inner lateral plates positioned at an inner portion, in the vehicle width direction, of the side sill, a thickness of an inner lateral plate positioned at an upper portion of the side sill overlapping at least a part of the cross member is different from a thickness of an inner lateral plate positioned at a lower portion of the side sill overlapping at least a part of the battery side frame.

11. The vehicle lower structure according to claim 8, wherein
an inner portion, in the vehicle width direction, of the side sill is hollow at an intermediate portion of the side sill between an upper portion of the side sill overlapping at least a part of the cross member and a lower portion of the side sill overlapping at least a part of the battery side frame.

12. The vehicle lower structure according to claim 7, wherein
the side sill includes a plurality of vertical plates bridged between the plurality of lateral plates, and
among the plurality of vertical plates, a thickness of an upper vertical plate positioned at an upper portion of the side sill overlapping at least a part of the cross member is different from a thickness of a lower vertical plate positioned at a lower portion of the side sill overlapping at least a part of the battery side frame.
